(19) United States
(12) Patent Application Publication
(10) Pub. No.: US 2007/0235529 A1
(43) Pub. Date: Oct. 11, 2007

(54) Method, system, and program product for identifying a product selected by a consumer

(75) Inventor: Mark E. Peters, Chapel Hill, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/399,895

(22) Filed: Apr. 7, 2006

(51) Int. Cl. G06K 15/00

(52) U.S. Cl. 235/383

(57) ABSTRACT

The invention provides a method, system, and program product for identifying a product selected by a consumer. In one embodiment, the invention includes: accessing a wireless network; identifying a location of a consumer electronic device carried by a consumer by allowing the wireless network to identify a unique feature of the consumer electronic device; identifying a location of a first radio frequency identification (RFID) tag associated with a first product selected by the consumer; and coordinating the location of the consumer electronic device with the location of the first RFID tag.

### BACKGROUND OF THE INVENTION

1. Technical Field

The invention relates generally to the identification of consumer purchases, and more particularly, to the monitoring of products selected by a consumer by coordinating a location of a consumer electronic device (e.g., cellular phone or personal digital assistant) with a location of a radio frequency identification (RFID) tag associated with a product selected by a consumer.

2. Background Art

Many retailers would benefit from the ability to monitor which products are selected by a consumer for purchase while the consumer is still in the retailer's establishment. This may allow the consumer to easily manage his or her shopping list while shopping, thereby increasing customer satisfaction and loyalty to the retailer. In addition, this may allow the retailer to study the shopping habits of consumers (e.g., the order in which products are selected), direct consumers to particular checkout aisles based on the products they've selected, and prevent shoplifting by consumers.

Known methods of monitoring a consumer's selection of products include one of two approaches. The first approach requires the mounting on a shopping cart a device capable of identifying the selected products. Such devices may be capable of reading the product's universal product code (UPC) or an RFID tag associated with the product. There are a number of defects in such an approach. First, installing such devices on a shopping cart is quite expensive, often in excess of $1,000 per shopping cart. Second, the manner in which shopping carts are used makes it likely that such devices will eventually be damaged or lost. Finally, assuring the availability of such devices requires that the retailer maintain the devices (e.g., recharging, updating software, etc.) on a frequent basis. These and other challenges make the use of shopping cart-mounted devices an unattractive way to monitor products selected by a consumer.

The second approach requires a consumer to obtain from the retailer and carry with him/her an RFID tag capable of identifying the consumer and the coordination of the consumer's location and RFID tags associated with products selected by the consumer using an in-store RFID system. This approach, too, requires that the consumer register his/her RFID tags and this raises privacy concerns for many.

To this extent, a need exists for a method for monitoring products selected by a consumer that does not suffer from the deficiencies of known methods.

### SUMMARY OF THE INVENTION

The invention provides a method, system, and program product for identifying a product selected by a consumer (i.e., a consumer or any agent of a consumer). In one embodiment, the invention includes: accessing a wireless network; identifying a location of a consumer electronic device carried by a consumer by allowing the wireless network to identify a unique feature of the consumer electronic device; identifying a location of a first radio frequency identification (RFID) tag associated with a first product selected by the consumer; and coordinating the location of the consumer electronic device with the location of the first RFID tag.

A first aspect of the invention provides a method for identifying a product selected by a consumer, comprising: identifying a location of a first radio frequency identification (RFID) tag associated with a first product selected by the consumer; and coordinating the location of the first RFID tag with at least one of the following: a location of a consumer electronic device carried by a consumer and a second RFID tag associated with a second product selected by the consumer.

A second aspect of the invention provides a system for identifying a product selected by a consumer, comprising: a system for identifying a location of a first radio frequency identification (RFID) tag associated with a first product selected by the consumer; and a system for coordinating the location of the first RFID tag with at least one of the following: a location of a consumer electronic device carried by a consumer and a second RFID tag associated with a second product selected by the consumer.

A third aspect of the invention provides a program product stored on a computer-readable medium, which when executed, identifies a product selected by a consumer, comprising: program code for identifying a location of a first radio frequency identification (RFID) tag associated with a first product selected by the consumer; and program code for coordinating the location of the first RFID tag with at least one of the following: a location of a consumer electronic device carried by a consumer and a second RFID tag associated with a second product selected by the consumer.

A fourth aspect of the invention provides a method for deploying an application for identifying a product selected by a consumer, comprising: providing a computer infrastructure being operable to: identify a location of a first radio frequency identification (RFID) tag associated with a first product selected by the consumer; and coordinate the location of the first RFID tag with at least one of the following: a location of a consumer electronic device carried by a consumer and a second RFID tag associated with a second product selected by the consumer.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a diagram of a retail space utilizing an identification method and system according to the invention.

FIG. 2 shows a diagram of an alternative embodiment of the invention.

FIG. 3 shows a flow diagram of an illustrative method according to the invention.

FIG. 4 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for identifying a product selected by a consumer.

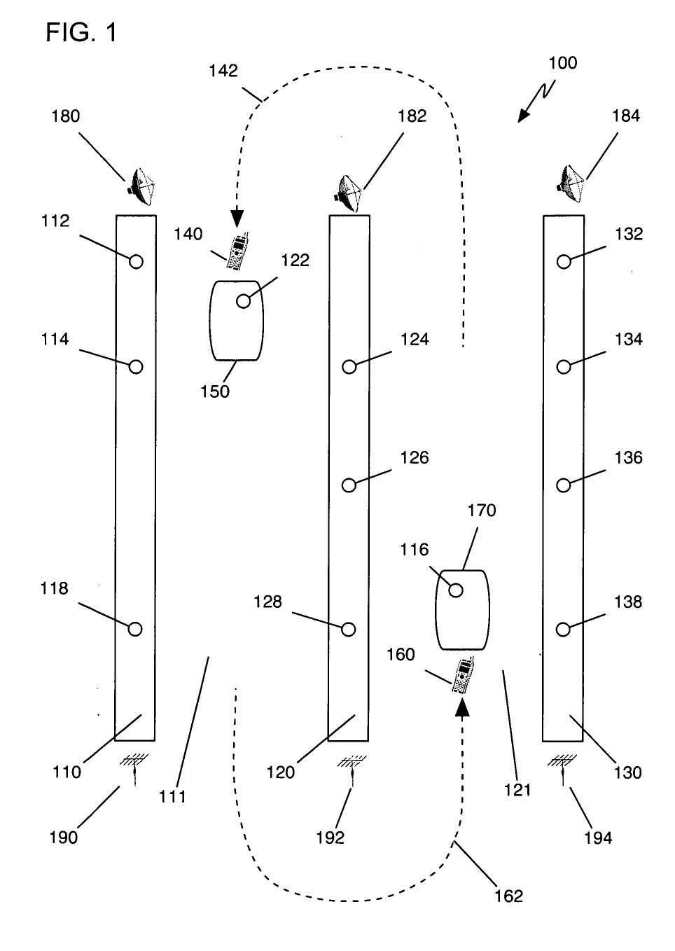

Referring now to the drawings, FIG. 1 shows a retail space 100 having a plurality of displays 110, 120, 130 of products 112, 114, 118, 124, 126, 128, 132, 134, 136, 138. The spaces between displays 110, 120, 130 form aisles 111, 121 through which consumers may travel. Deployed throughout retail space 100 are radio frequency identification (RFID) readers 190, 192, 194 capable of determining a location of an RFID tag within retail space 100. One or more RFID tags may be attached to or otherwise associated with a product 112, 114, etc.

As a consumer travels through aisles 111, 121 along paths 142, 162, the consumer may add products to his/her cart 150, 170. For example, a consumer has added product 122 to cart 150. Similarly, a consumer has added product 116 to cart 170. Once a product is added to a cart, RFID readers 190, 192, 194 are capable of tracking its movement throughout retail space 100.

Retail space 100 may optionally further include one or more devices having proximity and/or directional detection capability, such as a wireless network access points or cellular signal sensor 180, 182, 184 capable of determining a location and tracking the movement of a consumer's electronic device 140, 160. Such electronic devices include, for example, cellular telephones and personal digital assistants (PDAs). By determining and coordinating the locations of both an RFID tag associated with a product 116, 122 and an electronic device 140, 160 carried by a consumer, a retailer may identify the product 116, 120 as having been selected by the consumer. For example, by determining the locations of the RFID tag and the electronic device at a plurality of locations throughout retail space 100, it is possible to determine which products are “traveling with” a consumer and have therefore been selected by the consumer.

In one embodiment, a wireless network access point or cellular signal sensor 180, 182, 184 may identify a unique feature of the consumer electronic device, such as its media access control (MAC) address. Alternatively, a wireless network may identify the consumer electronic device using an electronic cookie accepted by the consumer electronic device, a network address, or an Internet protocol (IP) address. Such an embodiment may require the consumer to log onto the wireless network using his/her electronic device. Alternately, the sensors may correlate network interaction on the website with transmission to and from the consumer device.

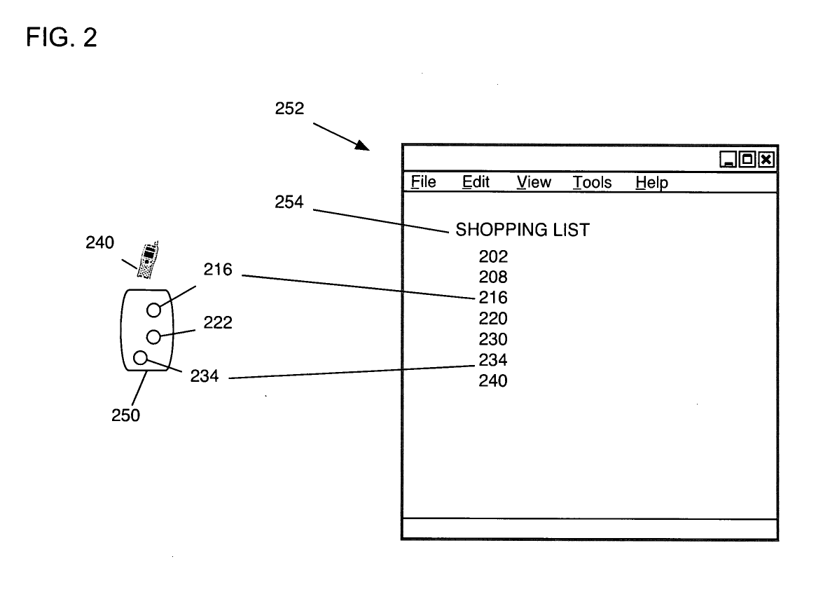

FIG. 2 shows an alternative embodiment of the invention, wherein products 216, 222, 234 “traveling with” a consumer are compared to a prepared shopping list 254 of products. Shopping list 254 may be included in a graphical user interface (GUI) and displayed on the consumer electronic device 240 or on a computer system (not shown) of the retailer. Shopping list 254 may be prepared by a consumer and stored on consumer electronic device 240 or a website maintained by the retailer. In the former case, the consumer may upload shopping list 254 to the retailer's computer system by logging onto a wireless network within retail space 100 (FIG. 1). Alternately, the consumer or the consumer's agent may have logged into the retailer website and composed the list. In the latter case, the consumer may download shopping list 254 from the website to consumer electronic device 240 using the same wireless network or any other technique for transferring electronic data. In one embodiment, a consumer may edit shopping list 254 (e.g., by marking an item on the shopping list as selected) as he/she selects products.

It should be recognized, however, that, in the case that the consumer has composed a shopping list 254 prior to beginning his/her shopping, it is not necessary to track the consumer's location using the consumer's electronic device 240. That is, it may be sufficient to correlate the shopping list 254 with the particular collection of products 216, 222, 234 determined to be “traveling” together.

Alternatively, a consumer may log onto the retailer's web server, wireless network, etc. using his/her electronic device 240 to access his/her shopping list 254. In such a case, correlating the consumer's shopping list 254 with products “traveling together” 216, 222, 234 may be improved, for example, by monitoring the consumer's modification of shopping list 254. For example, in the event that a product (e.g., 216) is added to the the group of products “traveling together” close in time to the consumer's removal of product 216 from shopping list 254, it may be possible to correlate the group of products with a particular consumer.

By comparing products “traveling with” a consumer to a prepared shopping list 254 associated with that consumer, a retailer may be better able to identify which products the consumer has chosen. For example, two consumers may travel approximately the same path throughout retail space 100, each selecting different products. In such a case, it may be difficult for RFID readers 190, 192, 194 within retail space 100 to determine which consumer has selected each product. That is, it may appear that a product is “traveling with” more than one consumer. If, however, each consumer is utilizing a prepared shopping list 254, a retailer may be able to determine which consumer is most likely to have selected the product by comparing the products “traveling with” the customers to the shopping list 254 of each customer.

The ability to correlate a particular group of products with a particular consumer may additionally be improved by a retailer engaging in some form of interaction with the customer. For example, in the case described above, where one or more products appears to be “traveling with” more than one consumer, a retailer may choose to query each consumer with whom the product(s) appear to be traveling via each consumer's electronic device. The retailer may, for example, transmit to each consumer's electronic device a question as to whether the consumer has recently added a product to his or her cart.

Once a shopping list 254 is correlated with a group of products “traveling together,” a number of benefits may be provided both the consumer and the retailer. For example, items on shopping list 254 may automatically be removed from shopping list 254 once it is determined that a corresponding product (e.g., 216) has been added to the consumer's cart 250 (i.e., is determined to be “traveling with” the consumer). In addition, products added to the consumer's cart 250 but not appearing on shopping list 254 may be automatically added to shopping list 254 or otherwise identified as “off list” purchases. Yet another benefit of such correlation is the automatic totaling of the cost of the consumer's purchases and, optionally, automatic payment for such purchases (i.e., the consumer need not use a checkout aisle where his/her purchases are re-scanned and re-totaled).

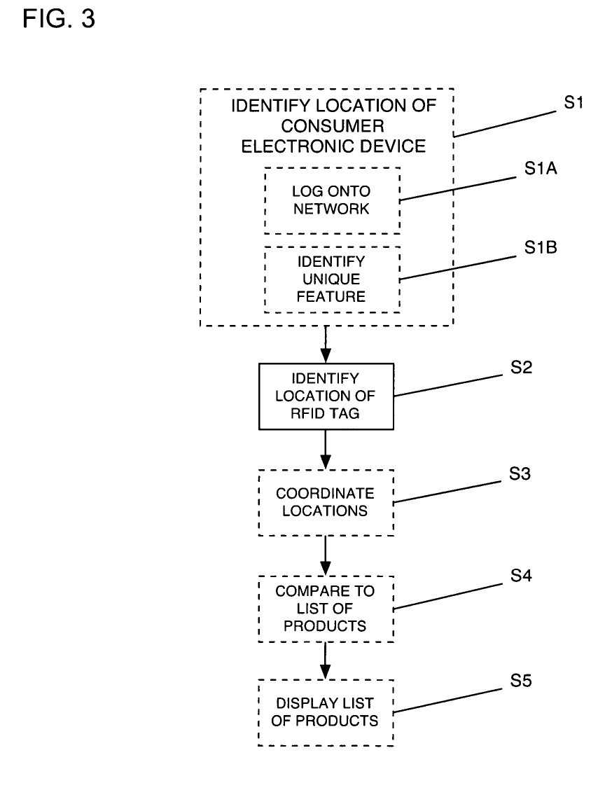

FIG. 3 shows a flow diagram of an illustrative method according to the invention. First, at optional step S1, one or more wireless access points or cellular signal sensors identifies a location of a consumer electronic device. As noted above, this may optionally include a consumer logging onto a wireless network at step S1A and/or a wireless network identifying a unique feature of the consumer electronic device at step S1B. Next, at step S2, one or more RFID readers identifies a location of an RFID tag associated with a product. At optional step S3, the location of the consumer electronic device identified at step S1 and the location of the RFID tag identified at step S2 are coordinated. As explained above, such coordination may allow a retailer to identify the product as “traveling with” the consumer and, therefore, as having been selected by the consumer. At optional step S4, products “traveling with” a consumer may be compared to a list of products (e.g., shopping list 254). At optional step S5, the list of products may be displayed, for example, on the consumer electronic device identified at step S1, a computer system of the retailer, or any other location.

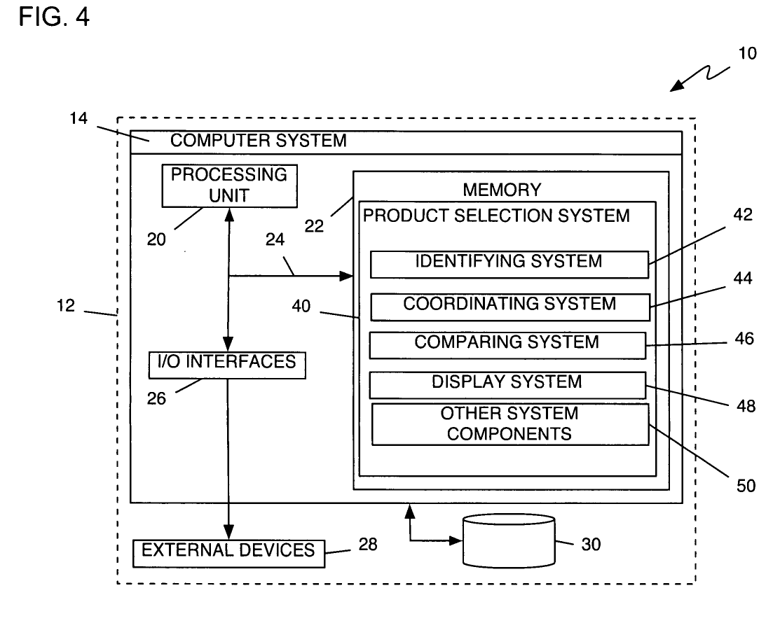

FIG. 4 shows an illustrative system 10 for identifying a product selected by a consumer. To this extent, system 10 includes a computer infrastructure 12 that can perform the various process steps described herein for identifying a product selected by a consumer. In particular, computer infrastructure 12 is shown including a computer system 14 that comprises a product selection system 40, which enables computer system 14 to identify a product selected by a consumer by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as product selection system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and product selection system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, product selection system 40 enables computer system 14 to identify a product selected by a consumer. To this extent, product selection system 40 is shown including an identification system 42, a coordinating system 44, a comparing system 46, and a display system 48. Operation of each of these systems is discussed above. Product selection system 40 may further include other system components 50 to provide additional or improved functionality to product selection system 40. It is understood that some of the various systems shown in FIG. 4 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for identifying a product selected by a consumer, it is understood that the invention further provides various alternative embodiments. For example, in one embodiment, the invention provides a computer-readable medium that includes computer program code to enable a computer infrastructure to identify a product selected by a consumer. To this extent, the computer-readable medium includes program code, such as product selection system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to identify a product selected by a consumer as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for identifying a product selected by a consumer. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for identifying a product selected by a consumer, comprising:
identifying a location of a first radio frequency identification (RFID) tag associated with a first product selected by the consumer; and
coordinating the location of the first RFID tag with at least one of the following: a location of a consumer electronic device carried by a consumer and a second RFID tag associated with a second product selected by the consumer.

2. The method of claim 1, wherein the location of the consumer electronic device is determined using at least one of the following: a wireless access point and a cellular signal sensor.

3. The method of claim 1, wherein the consumer electronic device is selected from a group consisting of: a cellular telephone and a personal digital assistant.

4. The method of claim 1, wherein coordinating includes associating at least two locations of the consumer electronic device with at least two locations of at least one of the first RFID tag and the second RFID tag.

5. The method of claim 1, further comprising:
accessing a wireless network.

6. The method of claim 5, wherein identifying a location of the consumer electronic device includes allowing the wireless network to identify a unique feature of the consumer electronic device.

7. The method of claim 6, wherein the unique feature includes at least one of the following: a cookie, a network address, an Internet protocol (IP) address, and a media access control (MAC) address.

8. The method of claim 1, further comprising:
comparing at least one of the first product and the second product with a list of products.

9. The method of claim 8, wherein the list of products includes a list of products prepared by the consumer.

10. The method of claim 8, further comprising:
displaying the list of products on the consumer electronic device.

11. A system for identifying a product selected by a consumer, comprising:
a system for identifying a location of a first radio frequency identification (RFID) tag associated with a first product selected by the consumer; and
a system for coordinating the location of the first RFID tag with at least one of the following: a location of a consumer electronic device carried by a consumer and a second RFID tag associated with a second product selected by the consumer.

12. The system of claim 11, wherein the location of the consumer electronic device is determined using at least one of the following: a wireless access point and a cellular signal sensor.

13. The system of claim 11, wherein the consumer electronic device is selected from a group consisting of: a cellular telephone and a personal digital assistant.

14. The system of claim 11, further comprising:
a system for accessing a wireless network.

15. The system of claim 14, wherein the system for identifying a location of the consumer electronic device includes a system for allowing the wireless network to identify a unique feature of the consumer electronic device.

16. The system of claim 1, further comprising:
a system for comparing the at least one product with a list of products.

17. A program product stored on a computer-readable medium, which when executed, identifies a product selected by a consumer, comprising:
program code for identifying a location of a first radio frequency identification (RFID) tag associated with a first product selected by the consumer; and
program code for coordinating the location of the first RFID tag with at least one of the following: a location of a consumer electronic device carried by a consumer and a second RFID tag associated with a second product selected by the consumer.

18. The program product of claim 17, wherein the consumer electronic device is selected from a group consisting of: a cellular telephone and a personal digital assistant.

19. The program product of claim 17, further comprising:
program code for comparing at least one of the first product and the second product with a list of products.

20. A method for deploying an application for identifying a product selected by a consumer, comprising:
providing a computer infrastructure being operable to:
identify a location of a first radio frequency identification (RFID) tag associated with a first product selected by the consumer; and
coordinate the location of the first RFID tag with at least one of the following: a location of a consumer electronic device carried by a consumer and a second RFID tag associated with a second product selected by the consumer.
